(19) United States
(12) Patent Application Publication
(10) Pub. No.: US 2024/0142644 A1
(43) Pub. Date: May 2, 2024

(54) RADIATION DETECTION APPARATUS, METHOD FOR MANUFACTURING SAME, SENSOR MODULE, AND CT APPARATUS

(71) Applicant: CANON KABUSHIKI KAISHA, Tokyo (JP)

(72) Inventors: TOMOHIRO HOSHINA, Kanagawa (JP); MASATO INOUE, Saitama (JP); KAITO MIYASHITA, Kanagawa (JP)

(21) Appl. No.: 18/473,565

(22) Filed: Sep. 25, 2023

(30) Foreign Application Priority Data
Oct. 31, 2022 (JP) 2022-175028

(51) Int. Cl. G01T 1/24

(52) U.S. Cl. CPC G01T 1/243; G01T 1/241; G01T 1/247

(57) ABSTRACT

A radiation detection apparatus includes a plurality of sensor units each including a semiconductor layer that converts radiation into a charge, a first surface located on a radiation incident side, and a second surface located on an opposite side to the first surface, a support member, an elastic member located between the second surface of each of the plurality of sensor units and the support member, and a substrate that covers the first surface of each of the plurality of sensor units. The elastic member presses each of the plurality of sensor units toward the substrate.

### BACKGROUND OF THE INVENTION

### Field of the Invention

The present disclosure relates to a radiation detection apparatus, a method for manufacturing the same, a sensor module, and a computerized tomography (CT) apparatus.

### Description of the Related Art

A known radiation detection apparatus includes a semiconductor layer that converts radiation into a charge. In the radiation detection apparatus according to Japanese Patent Laid-Open No. 2020-506375, a plurality of tiles each including such a semiconductor layer are attached side by side to a frame. In the tile of the radiation detection apparatus, an integrated circuit is disposed between the semiconductor layer and the frame. Variation in the thickness of the integrated circuit may be caused by manufacturing errors. In such cases, there is a possibility of variation in the height of the semiconductor layer from the frame among the tiles. Variation in height may lead to a reduction in the radiation detection accuracy.

### SUMMARY OF THE INVENTION

An aspect of the present disclosure can reduce variations in height in a semiconductor layer. According to some embodiments, a radiation detection apparatus comprising: a plurality of sensor units each including a semiconductor layer that converts radiation into a charge, a first surface located on a radiation incident side, and a second surface located on an opposite side to the first surface; a support member; an elastic member located between the second surface of each of the plurality of sensor units and the support member; and a substrate that covers the first surface of each of the plurality of sensor units, wherein the elastic member presses each of the plurality of sensor units toward the substrate is provided.

Further features of the present invention will become apparent from the following description of exemplary embodiments with reference to the attached drawings.

### BRIEF DESCRIPTION OF THE DRAWINGS

FIG. 1 is a block diagram for describing an example configuration of a CT apparatus according to some embodiments.

FIG. 2 is a perspective view for describing an example configuration of a radiation detection apparatus according to some embodiments.

FIG. 3 is a perspective schematic diagram for describing an example configuration of a sensor module according to some embodiments.

FIG. 4 is a cross-sectional view for describing an example configuration of a sensor unit according to some embodiments.

FIG. 5 is a cross-sectional view for describing an example of the effects of an elastic member according to some embodiments.

FIGS. 6A to 6D are cross-sectional views for describing modified examples of the elastic member according to some embodiments.

FIGS. 7A to 7E are cross-sectional views for describing an example of a method for manufacturing the elastic member according to some embodiments.

FIGS. 8A and 8B are cross-sectional views for describing an example of a method for manufacturing the sensor unit according to some embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Radiation in the following description may include α-rays, β-rays, and γ-rays, which are beams of particles (including photons) emitted due to radioactive decay, as well as beams with approximately equal or greater energy, such as X-rays, a particle beam, and cosmic rays. Note that in the present application, X-ray and γ-ray photons and β-ray and α-ray particles may be collectively referred to as radiation photons.

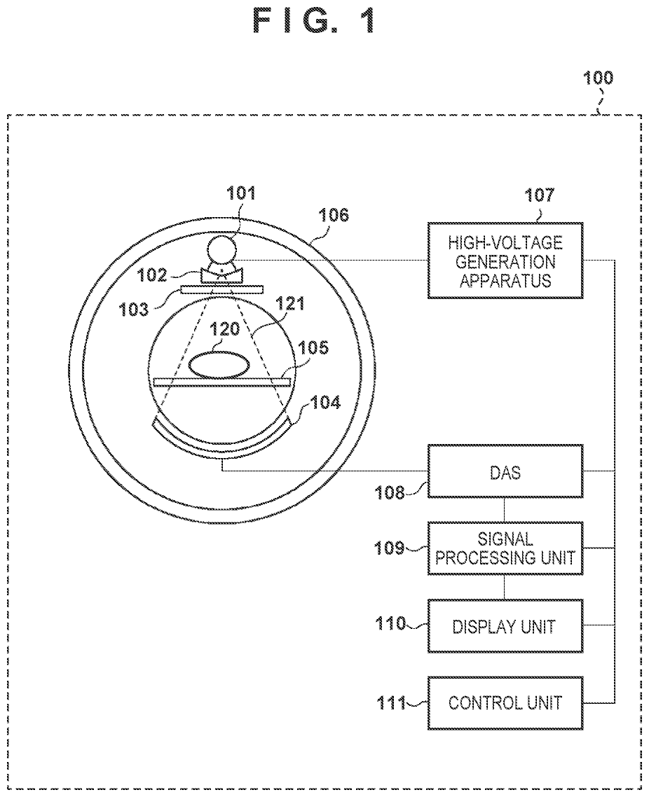

An example of the configuration of a CT apparatus 100 according to some embodiments will be described with reference to the block diagram in FIG. 1. The CT apparatus 100 may include a radiation generator 101, a wedge 102, a collimator 103, a radiation detection apparatus 104, a top plate 105, a rotating frame 106, a high-voltage generation apparatus 107, a data acquisition system (DAS) 108, a signal processing unit 109, a display unit 110, and a control unit 111. This configuration is an example, and the CT apparatus 100 may has a different configuration.

Note that the CT apparatus 100 may be an apparatus that can execute photon counting CT. In other words, the CT apparatus 100 described in the following embodiments may be an apparatus that can reconfigure CT image data with a high SN ratio by counting the radiation photons that passes through an inspection subject using the photon counting radiation detection apparatus 104. Also, the radiation detection apparatus 104 described in the following embodiments may be a direct conversion detector that directly converts the radiation photons to a charge proportional to the energy.

The radiation generator 101 emits radiation toward the radiation detection apparatus 104. The radiation generator 101 includes a vacuum tube for generating X-rays, for example. A high voltage and a filament current is supplied from the high-voltage generation apparatus 107 to the vacuum tube of the radiation generator 101. X-rays are generated by emitting thermionic electrons from the negative electrode (filament) toward the positive electrode (target).

The wedge 102 is a filter for adjusting the amount of radiation 121 emitted from the radiation generator 101. The wedge 102 attenuates the radiation amount so that the radiation 121 emitted from the radiation generator 101 to an inspection subject 120 has a predetermined distribution. The collimator 103 includes a lead plate or the like that narrows the emission range of the radiation that passes through the wedge 102. The radiation 121 generated by the radiation generator 101 is formed into a cone beam by the collimator 103 and emitted to the inspection subject 120 on the top plate 105.

The radiation detection apparatus 104 detects the radiation 121 from the radiation generator 101 that passes through the inspection subject 120 and outputs a signal corresponding to the radiation amount to a DAS 108. The inspection subject 120 may be a living thing (for example, a human or an animal) or a non-living thing.

Note that each time a radiation photon is incident on the radiation detection apparatus 104, the radiation detection apparatus 104 may output a signal that enables the energy value of the radiation photon to be measured. The radiation photon is a radiation photon that is emitted from the radiation generator 101 and passes through the inspection subject 120, for example. The radiation detection apparatus 104 includes a plurality of detection elements that output one pulse of an electrical signal (analog signal) each time a radiation photon is incident on the detection elements. By counting the number of electrical signals (pulses), the number of radiation photons incident on the detection elements can be counted. Also, by executing arithmetic processing on the signal, the energy value of the radiation photon that has caused the output of the signal can be measured.

The detection element described above may include an electrode disposed on a semiconductor detection element made of cadmium telluride (CdTe), cadmium zinc telluride (CdZnTe), or the like. In other words, the radiation detection apparatus 104 is a direct conversion detector that directly converts incident radiation photons into electrical signals. The radiation detection apparatus 104 includes the plurality of detection elements described above and a plurality of application specific integrated circuits (ASICs) respectively connected to the detection elements that count the radiation photon detected by the detection elements. The ASICs count the number of radiation photons incident on the detection elements by discriminating between the charges output by the detection elements. Also, the ASICs measure the energy of the counted X-ray photons by executing an arithmetic process on the basis of the magnitude of the charges. Furthermore, the ASICs output the result of counting the radiation photons to the DAS 108 as digital data.

The DAS 108 generates detection data on the basis of the result of the counting processing input from the radiation detection apparatus 104. The detection data is sinogram, for example. The sinogram is data in which the results of the counting processing for the radiation photons incident on each detection element at each position of the radiation generator 101 are arranged. The sinogram is data in which the results of the counting processing are arranged in a two-dimensional cartesian coordinate system with view direction and channel direction as the axes. The DAS 108 generates a sinogram per column in the slice direction of the radiation detection apparatus 104, for example. The result of the counting processing is data in which the number of photons of radiations per energy bin is allocated. For example, the DAS 108 counts the photons (radiation photons) resulting from the radiation that is emitted from the radiation generator 101 and passes through the inspection subject 120 and discriminating between the energy levels of the counted radiation photons to obtain the counting processing result. The DAS 108 is implemented by a processor, for example.

The rotating frame 106 has an annular shape and can rotate. Inside the rotating frame 106, the radiation generator 101 (the wedge 102 and the collimator 103) and the radiation detection apparatus 104 are disposed on opposite sides relative to the top plate 105. The radiation generator 101 and the radiation detection apparatus 104 can rotate together with the rotating frame 106.

The high-voltage generation apparatus 107 includes a boost circuit and outputs a high voltage to the radiation generator 101. For example, the high-voltage generation apparatus 107 includes an electric circuit such as a transformer, a rectifier, or the like; a high-voltage generator that generates a high voltage to be applied to the radiation generator 101; and a radiation control unit that controls the output voltage in accordance with the radiation generated by the radiation generator 101. The high-voltage generator may be a transformer type or an inverter type of generator. The high-voltage generation apparatus 107 may be provided on the rotating frame 106 or may be provided on a not-illustrated fixed frame. The DAS 108 includes an analog/digital (A/D) conversion circuit and outputs a signal from the radiation detection apparatus 104 to the signal processing unit 109 as digital data.

The signal processing unit 109 processes the signal output from the radiation detection apparatus 104. The signal processing unit 109 may include a central processing unit (CPU), a read-only memory (ROM), and a random-access memory (RAM). The display unit 110 includes a flat display apparatus or the like and can display radiation images. The control unit 111 includes a CPU, a ROM, a RAM, and the like and controls the operations of the entire CT apparatus 100. For example, the control unit 111 includes a processing circuit with a CPU and the like and a driving mechanism such as a motor, an actuator, or the like. The control unit 111 receives input signal from an input interface and performs operation control of the gantry and the couch. For example, the control unit 111 controls the rotation of the rotating frame 106, the tilt of the gantry, and operations of the couch and the top plate, and the like. For example, the control unit 111, as an example of control to tilt the gantry, rotates the rotating frame 106 about an axis parallel with the X-axis direction on the basis of the input inclination angle (tilt). Note that the control unit 111 may be provided in the gantry or may be provided in a console apparatus.

The input interface accepts various types of input operations from an operator, converts the accepted input operation to an electrical signal, and outputs the electrical signal to the control unit 111. Also, for example, the input interface accepts, from an operator, an input operation such as a reconfigure condition for when reconfiguring the CT image data, an image processing condition for when generating a post-processing image from the CT image data, and the like. For example, the input interface is implemented by a mouse and keyboard, a trackball, a switch, a button, a joystick, a touchpad where input operations are performed by touching the operation surface, a touch screen including a display screen and a touchpad integrally formed, a non-contact input circuit using an optical sensor, an audio input circuit, or the like. The input interface may be provided in the gantry. Also, the input interface may include a tablet terminal or the like that can wirelessly communicate with the console apparatus body. Also, the input interface is not only limited to including physical operation components such as a mouse and keyboard. For example, another example of the input interface includes an electrical signal processing circuit that receives an electrical signal corresponding to an input operation from an external input device provided separately to the console apparatus and outputs the electrical signal to the control unit 111.

The signal processing unit 109 may include a preprocessing function. The signal processing unit 109 with the preprocessing function executes logarithmic conversion processing and offset correction processing, inter-channel sensitivity correction processing, beam hardening correction, and other similar preprocessing on the detection data output from the DAS 108 to generate projection data. Also, the signal processing unit 109 may include a reconfigure processing function. The signal processing unit 109 with the reconfigure processing function executes reconfigure processing using a filter correction back projection method, a successive approximation reconfiguration method, or the like on the projection data generated by the preprocessing function to generate CT image data. Also, the signal processing unit 109, with the reconfigure processing function, can store the reconfigured CT image data in the memory.

The projection data generated from the counting results obtained via photon counting CT includes information relating to the energy of X-rays attenuated by passing through the inspection subject 120. Thus, the signal processing unit 109 can reconfigure the CT image data of a specific energy component via the reconfigure processing function, for example. Also, the signal processing unit 109 can reconfigure the CT image data of each energy component via the reconfigure processing function, for example. Also, for example, the signal processing unit 109, with the reconfigure processing function, can allocate the color tone in accordance with the energy component to each pixel of the CT image data for each energy component and generate image data superimposed with a plurality of pieces of CT image data colored according to the energy components. Also, for example, the signal processing unit 109, with the reconfigure processing function, can generate image data that enables a substance to be identified by using the K-absorption edge inherent to the substance. Examples of other image data generated by the reconfigure processing function of the signal processing unit 109 include monochromatic X-ray image data, density image data, effective atomic number image data, and the like.

To reconfigure CT image data, projection data covering the full circumference, that is, 360 degrees, of the inspection subject or projection data covering 180 degrees plus a fan angle, in the case of a half scan method, is required. Any reconfiguration method is applicable to the present embodiment. For ease of description, in the examples described below, a reconfiguration (full scan reconfiguration) method is used in which reconfiguration is performed using projection data covering the full circumference, that is, 360 degrees, of the inspection subject.

The signal processing unit 109 may include an image processing function. The signal processing unit 109 with the image processing function can, on the basis of an input operation accepted from an operator via the input interface, convert the CT image data generated by the reconfigure processing function, using a known method, into image data such as a tomogram of a discretionary cross section and a three-dimensional image obtained via rendering processing. Also, the signal processing unit 109, with the image processing function, can store the converted image data in the memory.

The control unit 111 may include a scan control function. The control unit 111 with the scan control function controls the CT scan performed using the gantry. For example, the control unit 111, with the scan control function, controls the operations of the high-voltage generation apparatus 107, the radiation detection apparatus 104, the DAS 108, and a couch drive apparatus to control the acquiring processing for the counting results in the gantry. For example, the control unit 111, with the scan control function, controls acquiring processing of projection data for both imaging to acquire positioning images (scan images) and actual imaging (scanning) to acquire an image to use in diagnosis. Also, the control unit 111 may include a display control function. The control unit 111, with the display control function, can perform control to display the various types of image data stored by the memory on a display such as the display unit 110.

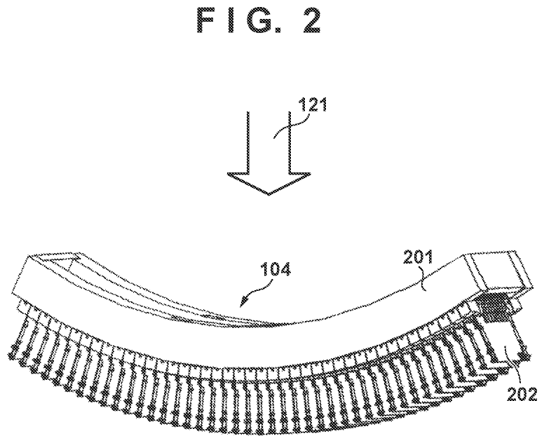

An example of the configuration of the radiation detection apparatus 104 will now be described with reference to the perspective view of FIG. 2. This configuration is an example, and the radiation detection apparatus 104 may has a different configuration. The radiation detection apparatus 104 includes a base 201 and a plurality of sensor modules 202. The base 201 has an arc shape recessed with respect to the radiation 121. The plurality of sensor modules 202 are arranged in the circumferential direction and fixed to the curved surface of the base 201. The base 201 is fixed to the rotating frame 106.

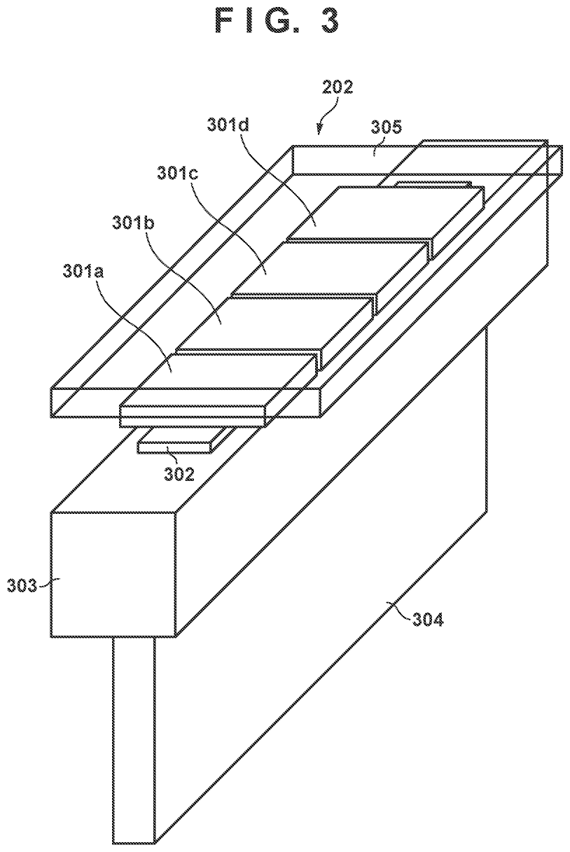

An example of a configuration of the sensor module 202 will now be described with reference to the perspective views of FIG. 3. This configuration is an example, and the sensor module 202 may have a different configuration. The plurality of sensor modules 202 included in the radiation detection apparatus 104 may all have the configuration described using FIG. 3. The sensor modules 202 may include a plurality of sensor units 301a to 301d, an elastic member 302, a frame 303, and a circuit board 304. Hereinafter, the plurality of sensor units 301a to 301d are referred to by the generic term sensor unit 301. The description of the sensor unit 301 may be applied to each of the plurality of sensor units 301a to 301d.

The sensor unit 301 generates a signal in accordance with the radiation incident on the sensor unit 301. The sensor unit 301 and the circuit board 304 are connected by a (non-illustrated) cable (flexible cable, for example). The signal generated at the sensor unit 301 is read out to the DAS 108 via the circuit board 304. The plurality of sensor units 301 are arranged side by side in the extending direction of the frame 303. In the example in FIG. 3, one sensor module 202 includes four sensor units 301, but the number of sensor units is not limited by this example. Also, in the example in FIG. 3, four sensor units 301 are arranged side by side in one row, but the plurality of sensor units may be arranged side by side in a plurality of rows.

The frame 303 is a member with sufficient rigidity so that the sensor unit 301 can be attached. The frame 303 may be referred to as a mount frame. The frame 303 may be made of metal, for example. The frame 303 functions as a support member for supporting the sensor unit 301. The circuit board 304 is attached to the frame 303. The plurality of sensor units 301 and the circuit board 304 are located on opposite sides relative to the frame 303. The frame 303 is fixed to the base 201. For example, the frame 303 may be mechanical fixed to the base 201 using a fastener such as a machine screw or the like or may be chemically fixed to the base 201 using an adhesive.

A substrate 305 is disposed at a position covering the sensor units 301 of the sensor module 202. In FIG. 3, for the sake of clarity, the substrate 305 is made transparent. The substrate 305 may be disposed in common for the plurality of sensor units 301 included in one sensor module 202. For example, for one sensor module 202, one integral substrate 305 may be disposed. Also, the substrate 305 may be disposed in common for the plurality of sensor modules 202. For example, for one radiation detection apparatus 104, one integral substrate 305 may be disposed.

The substrate 305 is fixed to the frame 303. The substrate 305 may be directly or indirectly fixed to the frame 303. For example, by fixing both the frame 303 and the substrate 305 to the base 201, the substrate 305 may be indirectly fixed to the frame 303. The substrate 305 may be directly, mechanical, or chemically fixed to the sensor unit 301.

The elastic member 302 is located between a lower surface 408 of each of the plurality of sensor units 301a to 301d and the frame 303. One elastic member 302 may be disposed in common for the plurality of sensor units 301. Alternatively, for each of the plurality of sensor units 301, a separate elastic member 302 may be disposed. For example, the elastic member 302 may have a wider width than the width of the lower surface of the sensor units 301 in the short side direction of the frame 303.

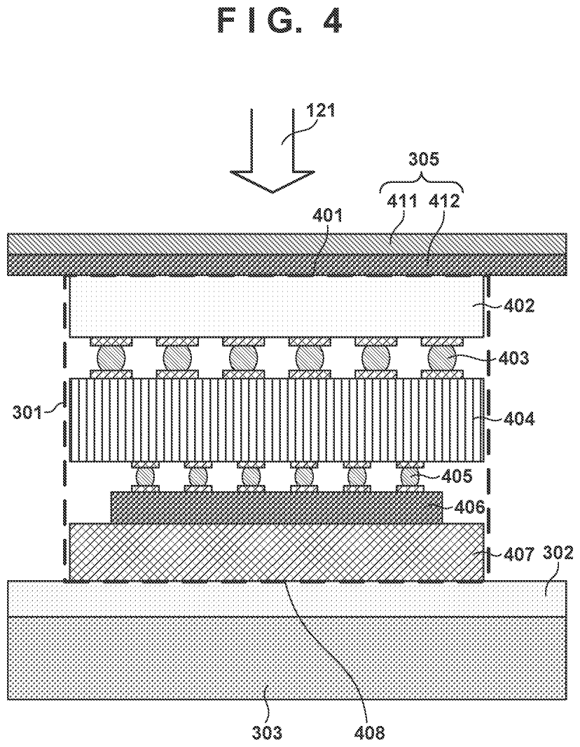

An example of the configuration of the sensor unit 301 will now be described with reference to the cross-sectional view of FIG. 4. This configuration is an example, and the sensor unit 301 may have a different configuration. The sensor unit 301 may include a semiconductor layer 402, an interposer 404, an integrated circuit 406, and a mounting substrate 407. Hereinafter, the surface of each member on the upper side of the paper is referred to as the upper surface, and the surface on the lower side of the paper is referred to the lower surface. The sensor unit 301 includes an upper surface 401 located on the radiation incident side and the lower surface 408 located on the opposite side to the upper surface 401.

The semiconductor layer 402 converts radiation into a charge. The upper surface 401 of the semiconductor layer 402 is located on the incident side of the radiation 121. In the example in FIG. 4, the semiconductor layer 402 is located at the uppermost portion (a position farthest from the frame 303) of the sensor unit 301. Accordingly, the upper surface of the semiconductor layer 402 is formed by the upper surface 401 of the sensor unit 301.

The semiconductor layer 402 may be a single-crystal substrate of a semiconductor that converts radiation into a direct charge such as cadmium zinc telluride (CdZnTe) or cadmium telluride (CdTe). The semiconductor layer 402 may be a single-crystal substrate of a semiconductor such as silicon (Si), lead iodide (MIA mercury iodide (HgI₂), bismuth iodide (BiI₃), and thallium bromide (TlBr).

The upper surface 401 of the sensor unit 301 is covered by the substrate 305. The substrate 305 may be in contact with the upper surface 401 of the sensor unit 301. Alternatively, an adhesive or an adhesive member may be disposed between the substrate 305 and the upper surface 401 of the sensor unit 301.

The substrate 305 may include an insulating layer 411 and an electrically conductive layer 412. The electrically conductive layer 412 faces the upper surface 401 of the sensor unit 301. The electrically conductive layer 412 may be in contact with the upper surface 401 of the sensor unit 301. Alternatively, an adhesive or an adhesive member may be disposed between the electrically conductive layer 412 and the upper surface 401 of the sensor unit 301. The electrically conductive layer 412 may be made of a metal such as aluminum, for example. The insulating layer 411 covers the electrically conductive layer 412. The insulating layer 411 may be made of a carbon fiber reinforced plastic (CFRP), for example.

The electrically conductive layer 412 may be used for applying a voltage to the semiconductor layer 402. When used in such as case, the electrically conductive layer 412 may be in contact with the semiconductor layer 402 or may be adhered to the semiconductor layer 402 using an electrically conductive adhesive. When the electrically conductive layer 412 is used to apply a voltage to the semiconductor layer 402, as illustrated in FIG. 4, each sensor unit 301 may not include a separate electrode for applying a voltage to the semiconductor layer 402. Alternatively, each sensor unit 301 may include a separate electrode for applying an electrode to the semiconductor layer 402. When each sensor unit 301 includes a separate electrode, the substrate 305 may not include the electrically conductive layer 412. When the electrically conductive layer 412 is disposed in common for the semiconductor layers 402 of the plurality of sensor units 301 as in the example in FIG. 4, variation in the voltage supplied to the semiconductor layers 402 can be reduced.

The electrode formed on the lower surface of the semiconductor layer 402 and the electrode formed on the upper surface of the interposer 404 are electrically and physically connected to one another via bumps 403. On the lower surface of the semiconductor layer 402, the individual electrode is formed corresponding to the pixel of the sensor unit 301. The electrode formed on the lower surface of the interposer 404 and the electrode formed on the upper surface of the integrated circuit 406 are electrically and physically connected to one another via bumps 405. The bumps 403 and 405 are formed via soldering, for example. Instead of the bumps 403 and 405, an anisotropic conductive film (ACF) may be used. The interposer 404 relays signals between the semiconductor layer 402 and the integrated circuit 406. The interposer 404 may be omitted.

The integrated circuit 406 is attached to the mounting substrate 407. The integrated circuit 406 may be energy-resolving counting electronics (ERCE). For example, the integrated circuit 406 may include a function for counting electric pulses generated when a radiation photon is incident on the semiconductor layer 402. Alternatively, the integrated circuit 406 may read out the voltage in accordance with the charge accumulated in the semiconductor layer 402 from the semiconductor layer 402.

In the example in FIG. 4, the mounting substrate 407 is located at the lowermost portion (a position closest to the frame 303) of the sensor unit 301. Accordingly, the lower surface of the mounting substrate 407 is formed by the lower surface 408 of the sensor unit 301. The elastic member 302 is located between the sensor unit 301 and the frame 303. The elastic member 302 is in contact with the lower surface 408 of the sensor unit 301 and the frame 303.

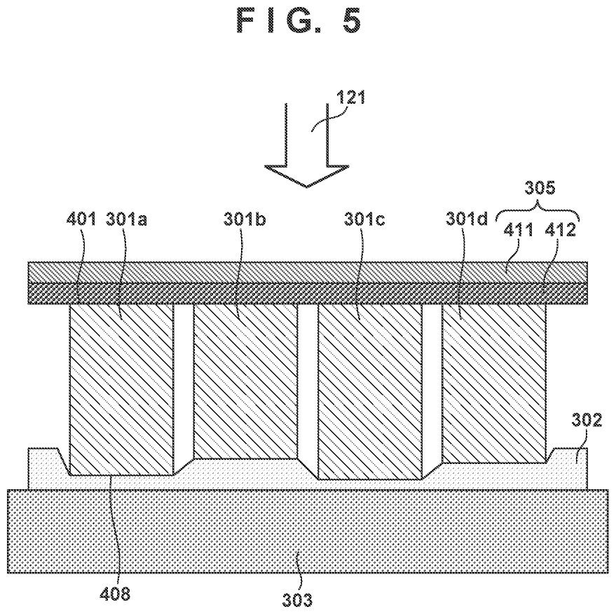

The effects of the elastic member 302 will now be described with reference to the cross-sectional view in FIG. 5. The thickness (in other words, the distance from the upper surface to the lower surface) of the plurality of sensor units 301a to 301d has variation due to manufacturing errors or the like. Accordingly, when the plurality of sensor units 301a to 301d are directly attached on the flat surface of the frame 303, variation in the height (for example, the distance from the frame 303) of the semiconductor layer 402 is caused. As a result, radiation being incident from the side of the semiconductor layer occurs more often, and the radiation detection accuracy by the radiation detection apparatus 104 is reduced.

The elastic member 302 according to some embodiments has elasticity and thus presses the plurality of sensor units 301 toward the substrate 305. As a result, the upper surfaces 401 of the plurality of sensor units 301 are aligned with the lower surface of the substrate 305. The variation in the distance from the substrate 305 of the upper surfaces 401 of the plurality of sensor units 301 is less than the variation in the distance from the substrate 305 of the lower surfaces 408 of the plurality of sensor units 301. The variation in distance may be measured in terms of dispersion, in terms of the difference between a maximum value and a minimum value, or using a different measure.

As described above, since the lower surface of the substrate 305 is used to align the plurality of sensor units 301, the lower surface of the substrate 305 may be a smooth flat surface. When one substrate 305 is used in common for the plurality of sensor modules 202, the substrate 305 may be curved to match the shape of the base 201. In this case, the lower surface of the substrate 305 may be a smooth curved surface. The lower surface of the substrate 305 may include a smooth surface at the portions that comes into contact with the upper surfaces 401 of the plurality of sensor units 301, and the other portions may not be smooth (for example, may include an opening).

The entire elastic member 302 may have elasticity, or only a portion of the elastic member 302 may have elasticity. The elastic member 302 having elasticity means that the thickness of the elastic member 302 changes to a greater degree than the difference in thickness of the plurality of sensor units 301, and a force directed toward the substrate 305 can be applied to the plurality of sensor units 301. The elasticity of the elastic member 302 may be equal to the elasticity of a substance with a hardness ranging from Shore A0 to Shore A70, for example.

The elastic member 302 may include a portion with a thermal conductivity of 1.5 W/(m·K) or greater. The upper limit of the thermal conductivity of the elastic member 302 is not limited and may be 10 W/(m·K) or less, 50 W/(m·K) or less, 100 W/(m·K) or less, for example. By the elastic member 302 including a portion with high thermal conductivity, the heat generated at the sensor unit 301 can readily be transferred to the frame 303 via the elastic member 302.

The substrate 305 may include a grid for reducing scattered rays. By the substrate 305 having both the function of aligning the sensor units 301 and the function of reducing scattered rays, the number of components of the radiation detection apparatus 104 can be decreased.

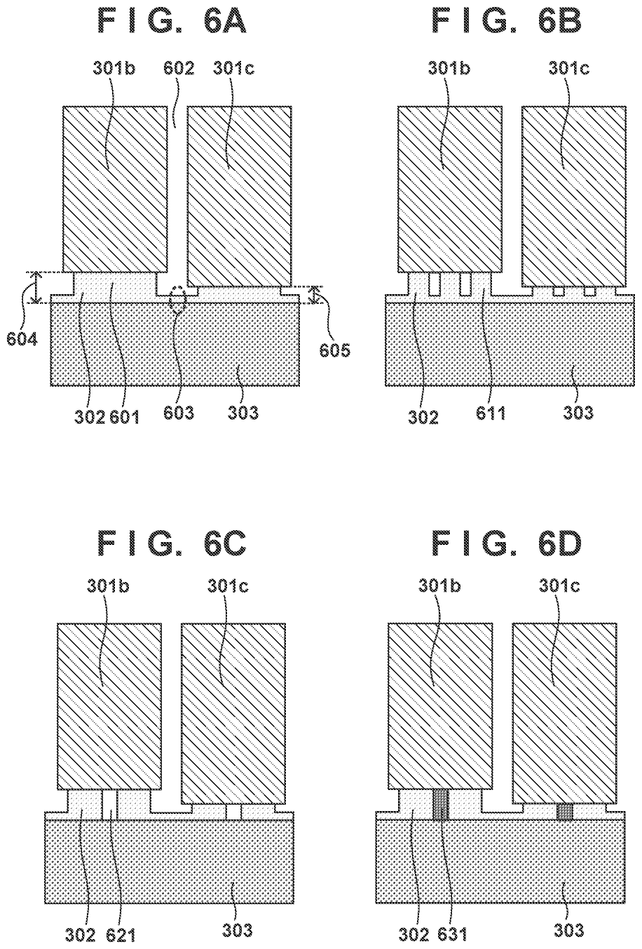

Modified examples of the elastic member 302 will now be described with reference to the cross-sectional views in FIGS. 6A to 6D. In the modified example illustrated in FIG. 6A, the elastic member 302 has a reduced thickness at a portion that overlaps a gap (a gap 602 between the sensor unit 301b and the sensor unit 301c) between the plurality of sensor units 301. Specifically, the thickness of a portion 603 of the elastic member 302 overlapping the gap 602 between the plurality of sensor units 301 is less than the distance between the lower surfaces 408 of the plurality of sensor units 301 and the frame 303. For example, the thickness of the portion 603 is less than a distance 604 between the lower surface 408 of the sensor unit 301b and the frame 303. The thickness of the portion 603 is also less than a distance 605 between the lower surface 408 of the sensor unit 301c and the frame 303.

By reducing the thickness of the portion 603 in this manner, the sensor units 301 are supported via protrusion portions 601 of the elastic member 302. By including the adjacent protrusion portions 601 separated in the horizontal direction (the direction parallel with the lower surface 408), misalignment in the horizontal direction caused by the elastic member 302 deforming when the sensor units 301 are pressed against the frame 303 is suppressed. The lower surfaces 408 of the plurality of sensor units 301 may each include a portion in contact with the elastic member 302 and a portion not in contact with the elastic member 302. By making the upper surfaces of the protrusion portions 601 having ample size with respect to the lower surfaces 408 of the sensor units 301, interference between the adjacent protrusion portions 601 can be further suppressed.

In the example in FIG. 6A, each sensor unit 301 is supported by one protrusion portion 601. Alternatively, in the modified example illustrated in FIG. 6B, the elastic member 302 includes a plurality of protrusion portions 611 at positions overlapping the sensor units 301. Each sensor unit 301 is supported by the plurality of protrusion portions 611.

In the modified example illustrated in FIG. 6C, the elastic member 302 includes through holes 621 at positions overlapping the sensor units 301. The through hole 621 extends from the lower surface 408 of the sensor unit 301 to the upper surface of the frame 303.

In the modified example illustrated in FIG. 6D, the elastic member 302 includes highly thermally conductive members 631 at positions overlapping the sensor units 301. The portions of the elastic member 302 where the highly thermally conductive members 631 are formed have a higher thermal conductivity than the other portions. This improves the heat dissipation efficiency from the sensor units 301 to the frame 303. The highly thermally conductive member 631 may be a heat dissipating rubber, for example.

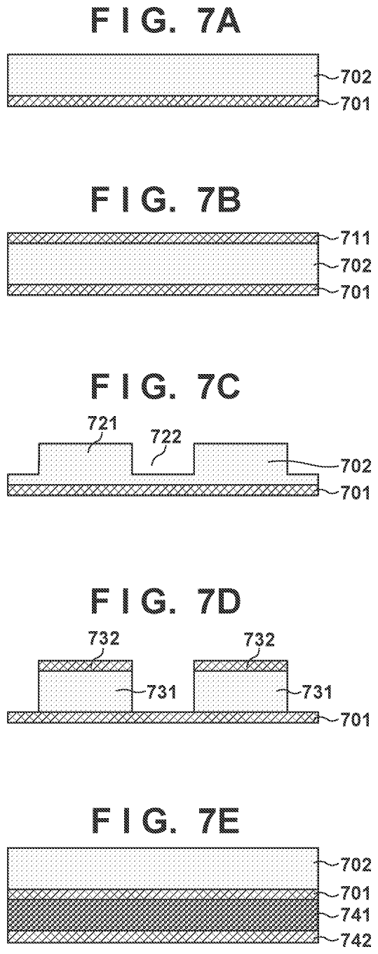

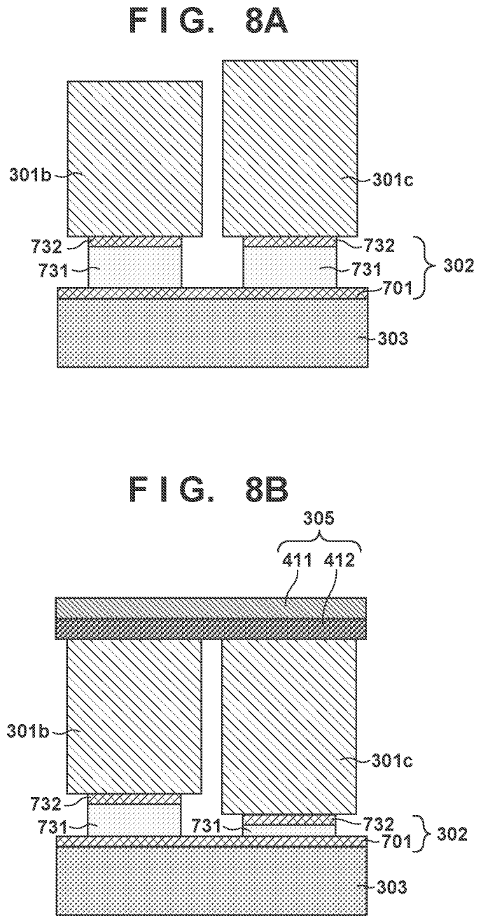

An example of the method for manufacturing the radiation detection apparatus 104 will now be described with reference to FIGS. 7A to 8B. First, the elastic member 302 is formed via a method such as that illustrated in FIGS. 7A to 7E. In the example illustrated in FIG. 7A, an integral damper member 702 is bonded to an adhesive member 701 to form the elastic member 302.

The damper member 702 may be made of a discretionary material having elasticity. For example, the damper member 702 may be made of rubber (for example, silicon, urethane, or acrylic rubber), resin (for example, acrylic-based, epoxy-based, olefin-based, or silicon-based), a foam body, or the like. The damper member 702 may include a filler. The thickness of the damper member 702 may be 10 mm or less, for example, and may range from 0.2 mm to 2 mm, for example. The elasticity of the damper member 702 may be equal to the elasticity of a substance with a hardness ranging from Shore A0 to Shore A70, for example. By the elastic member 302 including the damper member 702 in this manner, the elastic member 302 is given elasticity.

The adhesive member 701 is used to fix the elastic member 302 to the frame 303. The elastic member 302 may not include an adhesive member on the upper surface of the damper member 702. In this case, the damper member 702 comes into contact with the lower surface 408 of the sensor unit 301. In the radiation detection apparatus 104, since the damper member 702 is pressed against the sensor unit 301, the friction force between the two reduces misalignment between the two.

As illustrated in FIG. 7B, the elastic member 302 may include an adhesive member 711 on the upper surface of the damper member 702. The adhesive member 711 is used to fix the damper member 702 to the sensor unit 301. The adhesive member 711 being provided makes attaching the elastic member 302 to the sensor unit 301 easy.

As illustrated in FIG. 7C, the elastic member 302 may include a plurality of protrusion portions 721 on the upper surface. After the damper member 702 is bonded to the adhesive member 701 as illustrated in FIG. 7A, the plurality of protrusion portions 721 may be formed by forming a groove 722 in the upper surface of the damper member 702 via a half cut, for example. The protrusion portions 721 correspond to the protrusion portions 601 in FIGS. 6A and 6B. The elastic member 302 may include an adhesive member on each protrusion portion 601.

As illustrated in FIG. 7D, the elastic member 302 may be formed by bonding a plurality of damper members 731 to the adhesive member 701. The material, thickness, and elasticity of the damper members 731 may be the same as that of the damper member 702. In the example in FIG. 7D, the elastic member 302 includes an adhesive member 732 on each damper member 731. Alternatively, the elastic member 302 may not include the adhesive member 732. In the elastic member 302 in FIG. 7D, since the damper members 731 are provided at positions overlapping the gap between the plurality of sensor units 301, interference caused the deformation of the damper members 731 can be suppressed.

As illustrated in FIG. 7E, the elastic member 302 may further include a core member 741 and an adhesive member 742 below the adhesive member 701. Also, the elastic member 302 illustrated in FIGS. 7B to 7D may also further include the core member 741 and the adhesive member 742 below the adhesive member 701. The core member 741 may be made of PET, nonwoven fabric, or a foam body. The core member 741 may or may not have elasticity.

Next, as illustrated in FIG. 8A, the elastic member 302 is disposed between the plurality of sensor units 301 and the frame 303. The plurality of sensor units 301 and the frame 303 may be prepared using a known method. In the example in FIG. 8A, the elastic member 302 illustrated in FIG. 7D is used, but the elastic member 302 with a different configuration may be used. Thereafter, as illustrated in FIG. 8B, with the plurality of sensor units 301 pressed toward the frame 303 by the lower surface of the substrate 305, the substrate 305 is fixed to the frame 303.

The method described above will be described in more detail below. In one example, the elastic member 302 is fixed to the frame 303 using the adhesive member 701. Thereafter, the elastic member 302 is fixed to the plurality of sensor units 301 using the adhesive member 732. When the elastic member 302 without an adhesive member on the upper surface is used, the plurality of sensor units 301 are disposed on the elastic member 302. Thereafter, the upper surfaces 401 of the plurality of sensor units 301 cover the substrate 305, the substrate 305 is pressed toward the frame 303, and the substrate 305 is fixed to the frame 303 in this state. The sensor modules 202 formed in this manner are fixed to the base 201.

In another example, the elastic member 302 is fixed to the frame 303 using the adhesive member 701. Thereafter, the elastic member 302 is fixed to the plurality of sensor units 301 using the adhesive member 732. When the elastic member 302 without an adhesive member on the upper surface is used, the plurality of sensor units 301 are disposed on the elastic member 302. Thereafter, the substrate 305 is fixed to the base 201. Thereafter, with the upper surfaces 401 of the plurality of sensor units 301 in contact with the substrate 305, the frame 303 is pressed against the base 201, and the frame 303 is fixed to the base 201 in this state. In this manner, the substrate 305 is fixed relative to the frame 303.

In yet another example, the damper members 731 of the elastic member 302 are attached to the sensor unit 301 before the frame 303. First, the individual damper members 731 are fixed to the individual sensor units 301 using the individual adhesive members 732. Thereafter, the adhesive member 701 is bonded to the upper surface of the frame 303, and the damper members 731 and the sensor units 301 are fixed to the adhesive member 701. The substrate 305 may be fixed to the frame 303 via any of the methods described above.

In the embodiments described above, the radiation detection apparatus 104 has been described in the context of the CT apparatus 100. However, alternatively, the radiation detection apparatus 104 may be used in another apparatus such as a fluoroscopic examination apparatus, an article inspection apparatus, and the like. Also, in the embodiments described above, the radiation detection apparatus 104 that detects radiation has been described. However, the embodiments are not limited thereto, and, for example, the embodiments described above are applicable to a radiation detector that detects γ-rays, particle radiation, and the like. Also, other than the CT apparatus 100, the embodiments described above are also applicable to a radiation examination apparatus including the radiation detection apparatus 104. In such a case, the radiation examination apparatus, for example, includes a Positron Emission Tomography (PET) apparatus, a Single Photon Emission Computed Tomography (SPECT) apparatus, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-175028, filed Oct. 31, 2022, which is hereby incorporated by reference herein in its entirety.

What is claimed is:

1. A radiation detection apparatus comprising:
a plurality of sensor units each including a semiconductor layer that converts radiation into a charge, a first surface located on a radiation incident side, and a second surface located on an opposite side to the first surface;
a support member;
an elastic member located between the second surface of each of the plurality of sensor units and the support member; and
a substrate that covers the first surface of each of the plurality of sensor units,
wherein the elastic member presses each of the plurality of sensor units toward the substrate.

2. The radiation detection apparatus according to claim 1, wherein the elastic member includes a damper member.

3. The radiation detection apparatus according to claim 1, wherein variation in distance from the substrate of the first surfaces of the plurality of sensor units is less than variation in distance from the substrate of the second surfaces of the plurality of sensor units.

4. The radiation detection apparatus according to claim 1, wherein the second surface of each of the plurality of sensor units includes a first portion in contact with the elastic member and a second portion not in contact with the elastic member.

5. The radiation detection apparatus according to claim 1, wherein
the elastic member is disposed in common for the plurality of sensor units, and
a thickness of a portion of the elastic member that overlaps a gap between the plurality of sensor units is less than a distance between the second surface of each of the plurality of sensor units and the support member.

6. The radiation detection apparatus according to claim 1, wherein the elastic member includes a portion with a thermal conductivity of 1.5 W/(m·K) or greater.

7. The radiation detection apparatus according to claim 1, wherein the elastic member includes a first portion and a second portion with a higher thermal conductivity than the first portion.

8. The radiation detection apparatus according to claim 1, wherein the substrate includes an electrically conductive layer that faces the first surface of each of the plurality of sensor units and an insulating layer that covers the electrically conductive layer.

9. The radiation detection apparatus according to claim 1, wherein the substrate includes a grid for reducing scattered rays.

10. The radiation detection apparatus according to claim 1, further comprising:
a plurality of sensor modules each including the plurality of sensor units, the elastic member, and the support member,
wherein the substrate is disposed in common for the plurality of sensor modules.

11. A radiation detection apparatus comprising:
a sensor unit including a semiconductor layer that converts radiation into a charge, a first surface located on a radiation incident side, and a second surface located on an opposite side to the first surface;
a support member;
a substrate that covers the first surface of each of a plurality of the sensor units; and
an elastic member located between the second surface of each of the plurality of sensor units and the support member for pressing each of the plurality of sensor units toward the substrate.

12. A CT apparatus comprising:
the radiation detection apparatus according to claim 1;
a radiation generator that emits radiation toward the radiation detection apparatus; and
a signal processing unit that processes signals output from the radiation detection apparatus.

13. ACT apparatus comprising:
the radiation detection apparatus according to claim 11;
a radiation generator that emits radiation toward the radiation detection apparatus; and
a signal processing unit that processes signals output from the radiation detection apparatus.

14. The CT apparatus according to claim 12, wherein
the radiation detection apparatus is a photon counting radiation detection apparatus, and
the signal processing unit generates image data using a counting result of radiation photons resulting from radiation that has passed through an inspection subject.

15. A sensor module comprising:
a sensor unit including a semiconductor layer that converts radiation into a charge, a first surface located on a radiation incident side, and a second surface located on an opposite side to the first surface;
a support member; and
an elastic member located between the second surface of each of a plurality of the sensor units and the support member.

16. The sensor module according to claim 15, further comprising:
a substrate that covers the first surface of each of the plurality of sensor units,
wherein the elastic member is located between the second surface of each of the plurality of sensor units and the support member for pressing each of the plurality of sensor units toward the substrate.

17. A method of manufacturing a radiation detection apparatus comprising:
disposing an elastic member between a plurality of sensor units that each include a semiconductor layer that converts radiation into a charge and a support member;
fixing a substrate to the support member in a state in which the plurality of sensor units are pressed toward the support member by the substrate.
